(19) United States
(12) Patent Application Publication
(10) Pub. No.: US 2023/0110575 A1
(43) Pub. Date: Apr. 13, 2023

(54) Firearms Cable Fastening Device

(71) Applicant: Francisco Chang Cinco, La Habra, CA (US)

(72) Inventor: Francisco Chang Cinco, La Habra, CA (US)

(21) Appl. No.: 17/497,140

(22) Filed: Oct. 8, 2021

(51) Int. Cl. F41C 27/00; F16G 11/10

(52) U.S. Cl. CPC F41C 27/00; F16G 11/10

(57) ABSTRACT

A firearm cable fastening device having a top side portion, one or more than one edge portion perpendicular to the top side portion, one or more than one attachment means for attaching the firearm cable fastening device to a firearm rail system, and one or more than one cable pass through indent.

### CROSS-REFERENCE TO RELATED APPLICATIONS

This Application claims the benefit under 35 U.S.C. § 119(e) of U.S. Provisional Pat. Application Ser. No. 61/796, 505, filed on Oct. 8, 2020, the contents of which are incorporated herein by reference in their entirety.

### FIELD OF THE INVENTION

The present invention is in the technical field of firearm rail system accessory attachments and more particularly to a firearm cable fastening device for a firearm rail system, that is quickly installed and secure.

### BACKGROUND

There are a variety of accessory attachment device for firearms. Among those are the M-LOK, and 1913 Picatinny Rails and the KeyMod rail system to name a few. Each of these systems is designed to have various accessories attached to the firearm for increased functionality.

However, several accessories require cable to be run around the barrel of the firearm, which can impede user performance and could actually be a hazard to the safe operation of the firearm. This can easily be seen in FIGS. ’s 1-3. Using various attachment systems leaves hazardous cables loose and present potentially life threatening problems for the user. In a military situation, these loose cables could give away the user’s position or interfere with the user’s ability to perform their duties without interference from the device attached to the firearm rail system.

For hunters or other sport shooters, theses loose cables can pose issues while treading through back country, making noise, or even snagging on limbs or brush. Every bad scenario from a simple annoyance to an accidental discharge of the firearm due to the loose cable catching. The potential disasters are legion. Currently none of the firearm rail systems have addressed this shortcoming.

Therefore, there is a need for a firearm cable fastening device for a firearm rail system, that is quickly installed and secure, overcoming the limitations of the prior art.

### BRIEF DESCRIPTION OF THE DRAWINGS

The present invention overcomes the limitations of the prior art by providing a firearm cable fastening device for a firearm rail system, that is quickly installed and secure.

These and other features, aspects and advantages of the present invention will become better understood with regard to the following description, appended claims, and accompanying figures where:

FIG. 1 is a prior art attachment showing hazardous loose cables;

FIG. 2 is another prior art attachment showing hazardous loose cables;

FIG. 3 is yet a another prior art attachment showing hazardous loose cables;

FIG. 4 is a perspective view of a firearm cable fastening device for a firearm rail system, that is quickly installed and secure, according to one embodiment of the present invention;

FIG. 5 is a top view of FIG. 4;

FIG. 6 is a side view of FIG. 4;

FIG. 7 is a bottom perspective view of FIG. 4;

FIG. 8 is a bottom view of FIG. 4;

FIG. 9 is a top perspective view of another embodiment of a firearm cable fastening device;

FIG. 10 is a bottom view of FIG. 9;

FIG. 11 is a top view of FIG. 9;

FIG. 12 is a front view of FIG. 9;

FIG. 13 is photographic view of a another embodiment of the device attached to an MLOK rail system; and

FIG. 14 is a is photographic view of a another embodiment of the device attached to an KeyMod rail system.

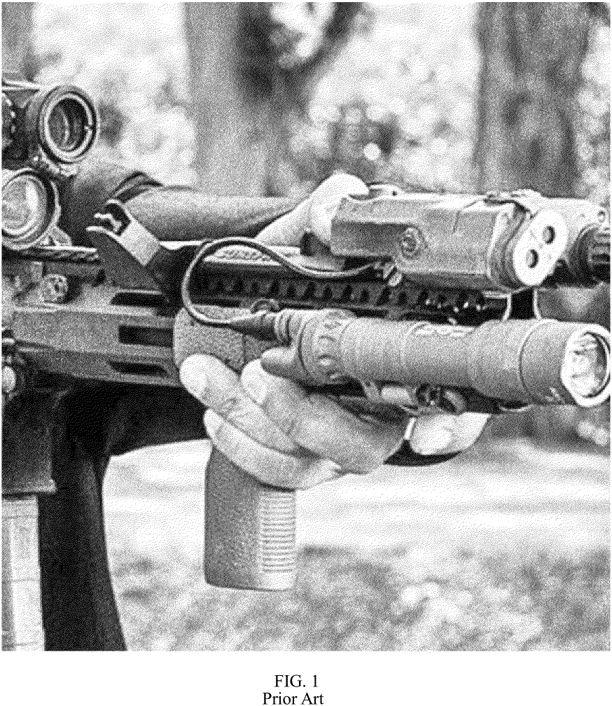

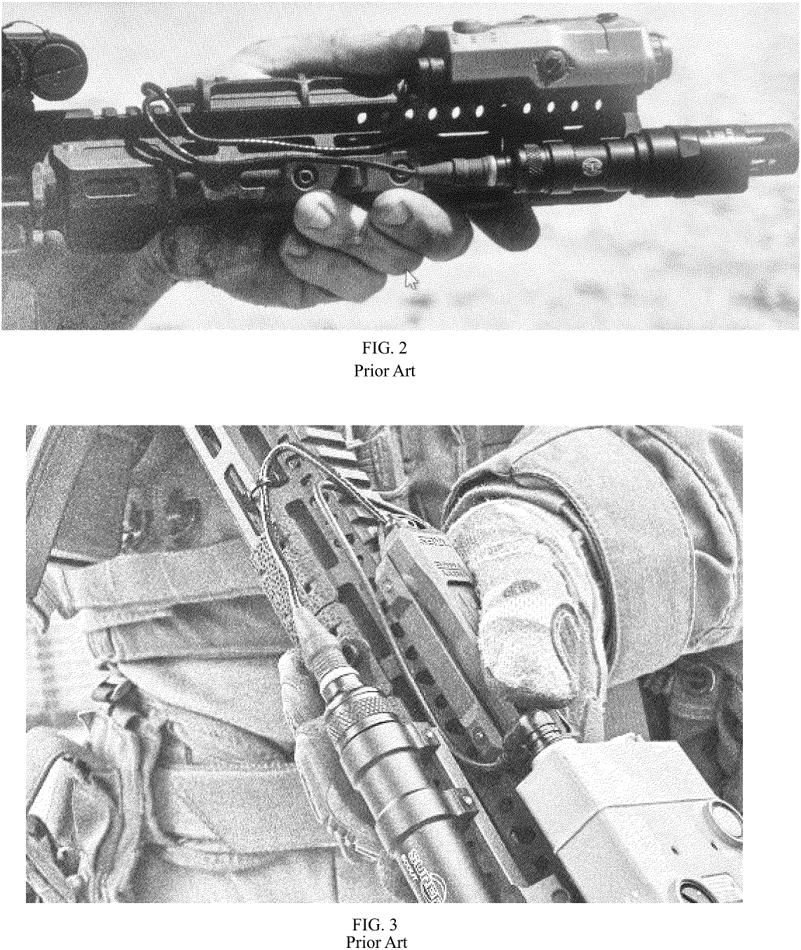

### SUMMARY

There is provided a firearm cable fastening device having a top side portion, one or more than one edge portion connected perpendicular to the top side portion, one or more than one attachment means for attaching the firearm cable fastening device to a firearm rail system and one or more than one cable pass through indent in the one or more than one edge portion. The device also has one or more than one connecting edge portion affixed to the top side portion and the one or more than one edge portion that is perpendicular to the top side portion. The top portion is smooth and flat. The one or more than one connecting edge is beveled or rounded. The one or more than one attachment means is a beveled opening or a quick release locking device. The one or more than one cable pass through indent is beveled or rounded.

The device also has one or more than one stand off post and one or more than one stand off base. The one or more than one stand off base and the one or more than one stand off post are the same.

There is also a firearm cable fastening device with a top side portion, wherein the top portion is smooth and round without any edge portions, one or more than one attachment means for attaching the device to a firearm rail system and one or more than one cable pass through indent. The device also has one or more than one connecting edge portion affixed to the top side portion and the one or more than one edge portion perpendicular to the top side portion. The connecting edge is beveled or rounded.

### DETAILED DESCRIPTION OF THE INVENTION

The present invention overcomes the limitations of the prior art by providing a firearm cable fastening device for a firearm rail system, that is quickly installed and secure.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any system, any device or part of a system or device disclosed in this disclosure will be determined by its intended use.

The intended duty of the firearm cable fastening device is to re-route, re-direct, stow, fasten, organize and reduce excess slack from any power cables attached to flashlights, laser aiming devices, infrared pointing peripherals and/or thermal optics units mounted onto the “Handguard, Fore End, Rail or Chassis” of firearms such as pistols, carbines, rifles, sub machine guns, machine guns, etc.

The firearm cable fastening device fastens onto these “Handguard, Fore End, Rail or Chassis” via the fastening screws and nuts and other attachment methods. The attaching areas can vary in size, shape and location depending on which manufacturer produces the “Handguard, Fore end, Rail or Chassis” of the firearm. The firearm cable fastening device will fully'or partially’ encapsulate and/or mount and direct the cable to the desired direction then secured with hardware. The components of the firearm cable fastening device can comprise metal, plastic or both metal and plastic.

Methods and device that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific details. Well-known circuits, structures and techniques may not be shown in detail in order not to obscure the embodiments. For example, circuits may be shown in block diagrams in order not to obscure the embodiments in unnecessary detail.

Also, it is noted that the embodiments may be described as a process that is depicted as a flowchart, a flow diagram, a structure diagram, or a block diagram. The flowcharts and block diagrams in the figures can illustrate the architecture, functionality, and operation of possible implementations of systems and methods according to various embodiments disclosed. In this regard, each block in the flowchart or block diagrams can represent a module, or segment, that can comprise one or more instructions for implementing the specified function(s). It should also be noted that, in some alternative implementations, the functions noted in the blocks may occur out of the order noted in the figures. Although a flowchart may describe the operations as a sequential process, many of the operations can be performed in parallel or concurrently. In addition, the order of the operations may be rearranged. A process is terminated when its operations are completed.

In the following description, certain terminology is used to describe certain features of one or more embodiments of the invention.

The term “firearm rail system” refers to any firearm rail interface system, rail integration system, or rail accessory system, for attaching accessories to firearms such as pistols, rifles and light machine guns, where the accessories commonly include tactical lights, laser aiming modules, forward hand grips for improving weapon handling, telescopic sights for long-range targets, and reflex sights/red-dot sights for short/medium-ranged targets, back-up iron sight, bipods/tripods, and bayonets among other accessories.

Various embodiments provide a firearm cable fastening device for a firearm rail system. One embodiment of the present invention provides a firearm cable fastening device for a firearm rail system. In another embodiment, there is provided a method for using the system. The system and method will now be disclosed in detail.

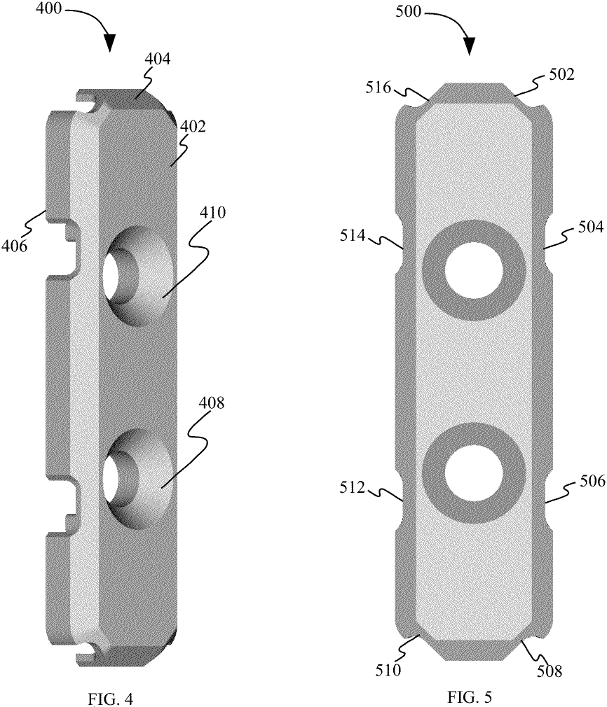

Referring now to FIG. 4 is a perspective view of a firearm cable fastening device 400 for a firearm rail system, that is quickly installed and secure, according to one embodiment of the present invention. As can be seen in this embodiment, the firearm cable fastening device for a firearm rail system comprises a top portion 402, a connecting edge 404, a perpendicular edge 406, and one or more than one attachment opening 408 and 410.

The top portion 402 is generally smooth and flat so as not to catch on the user’s clothing or anything else. In this embodiment, the connecting edge 404 is beveled. However, this is not meant to be limiting. Those with skill in the art with reference to this disclosure will understand that the connecting edge 404 can be rounded, multifaceted or non-existant. In the case where there is no connecting edge 404, the top portion 402 is directly connected to the perpendicular edge. As will also be understood with reference to this disclosure, the entire device 400 can be a round shape with the appropriate openings. The diagrams shown are examples only.

There is also one or more than one attachment opening 408 and 410. In this embodiment, the one or more than one attachment opening 408 and 410 is beveled for a machine screw that is typical on many firearm rail systems. Although the one or more than one attachment opening 408 and 410 is shown on the top portion 402 of the device, the actual placement of the one or more than one attachment opening will be determined by the attachment means that the firearm rail system uses. The one or more than one attachment opening 408 and 410 presented herein are for use with the MLOK rail system.

Referring now to FIG. 5, there is shown a top view 500 of the firearm cable fastening device 400 for a firearm rail system. Here, the one or more than one cable pass through indent 502, 504, 506, 508, 510, 512, 514, and 516 can be clearly seen. Each of the one or more than one cable pass through indent 502–516 can be placed anywhere on the firearm cable fastening device 400, depending on the firearm rail system used. The one or more than one cable pass through indent 502–516 shown in this example are for use with the MLOK rail system. Additionally, the one or more than one cable pass through indent 502–516 can comprise a smooth rounded edge, a beveled edge, a square edge or any other type of edge that can be contemplated. In a preferred embodiment the one or more than one cable pass through indent 502–516 comprise a smooth rounded edge so as to not split the cables running through the one or more than one cable pass through indent 502–516 over time.

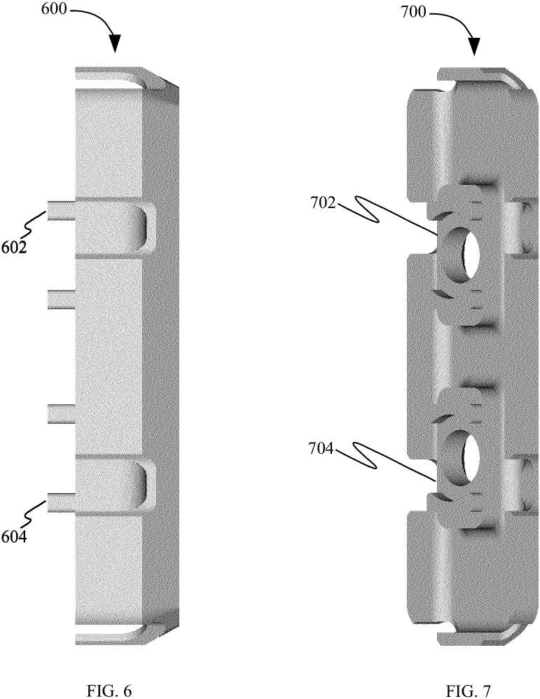

Referring now to FIG. 6, there is shown a side viewof 600 the firearm cable fastening device 400 for a firearm rail system. Here the one or more than one stand off post 602 and 604 can be seen. The one or more than one stand off post 602 and 604 has multiple purposes. First, the one or more than one stand off post 602 and 604 prevents the firearm cable fastening device 400 from crushing any cables. Additionally, the one or more than one stand off post 602 and 604 can prevent the firearm cable fastening device 400 from shifting positions on the user’s firearm rail system by interlocking with the firearm rail system. This way if any of one or more that one attachments to the firearm rail system come loose, or the user is going through particularly dense vegetation, the firearm cable fastening device 400 will remain in place and not slide around on the firearm rail system.

Referring now to FIG. 7, there is shown a bottom perspective view of the firearm cable fastening device for a firearm rail system. Here is shown, the one or more than one stand off base 702 and 704. The one or more than one stand off base 702 and 704 provide support for the one or more than one stand off post 602 and 604. In some cases it is contemplated that the one or more than one stand off post 602 and 604 and the one or more than one stand off base 702 and 704 will be a single unit and not individual elements. Also, the one or more than one stand off base 702 and 704 provides protection for the cables run throught the firearm cable fastening device 400 and from the one or more than one attachments for the firearm rail system. In addition, the one or more than one stand off base 702 and 704 provides cable routing paths, so that multiple cables can be protected by the firearm cable fastening device 400 an easily routed to the correct attachment. This reduces the weight of the firearm rail system, while still providing protection.

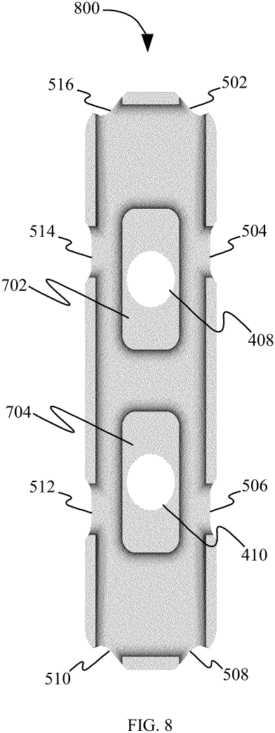

Referring now to FIG. 8, there is shown a bottom view 800 of the firearm cable fastening device 400 for a firearm rail system. In this embodiment, the one or more than one attachment opening 408-410, the one or more than one cable pass through indent 502-516 and the one or more than one stand off post 602 and 604 can be seen. In this embodiment, the one or more than one stand off post 602 and 604 and the one or more than one stand off base are 702-704 are the same. This is due to the fact that some firearm rail systems do not have openings where the one or more than one stand off post 602 and 604 can fit. Also, in this embodiment, the combined one or more than one stand off post 602 and 604 and the one or more than one stand off base are 702-704 are flush with the perpendicular edge 406.

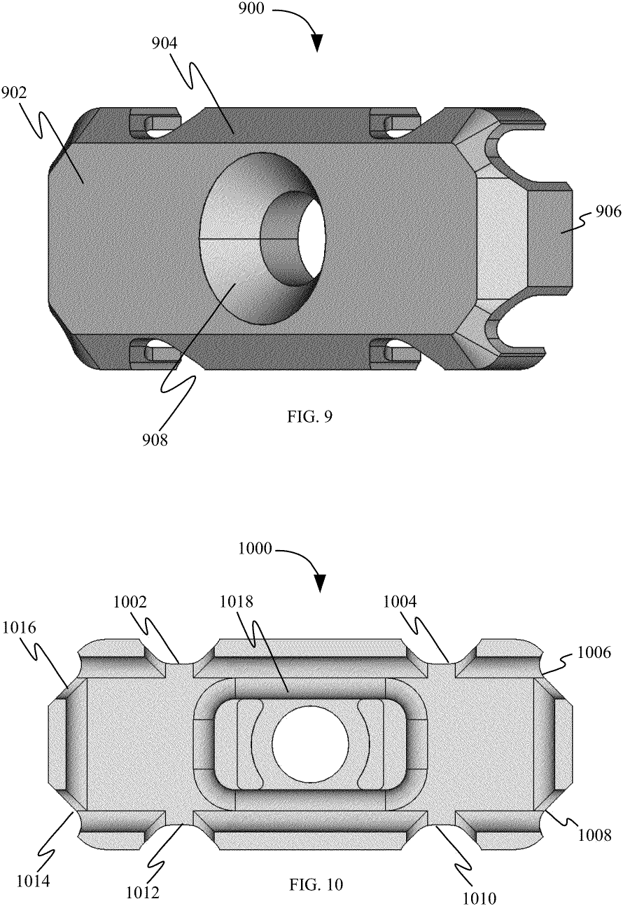

Referring now to FIG. 9, there is shown a top perspective view of another embodiment of a firearm cable fastening device 900 for a firearm rail system. In this embodiment, the can be seen a top portion 902, a connecting edge 904, a perpendicular edge 906, and an attachment opening 908. Each of the listed elements, functions in the same manner as described above. The only difference is this is an example of a singular firearm cable fastening device 900.

Referring now to FIG. 10, there is shown a bottom view 1000 of the firearm cable fastening device 900 for a firearm rail system. As noted in the previous paragraph, the one or more than one cable pass through indent 1002-1016 function in the exact same manner as previously discussed. The only difference being in the number and size of the one or more than one cable pass through indent 1002-1016, as an exemplar of what is possible with reference to this disclosure.

In this embodiment, there is a singular stand off base 1018 without any stand off posts as described above. Again, this is another example of contemplated variations of the invention described herein.

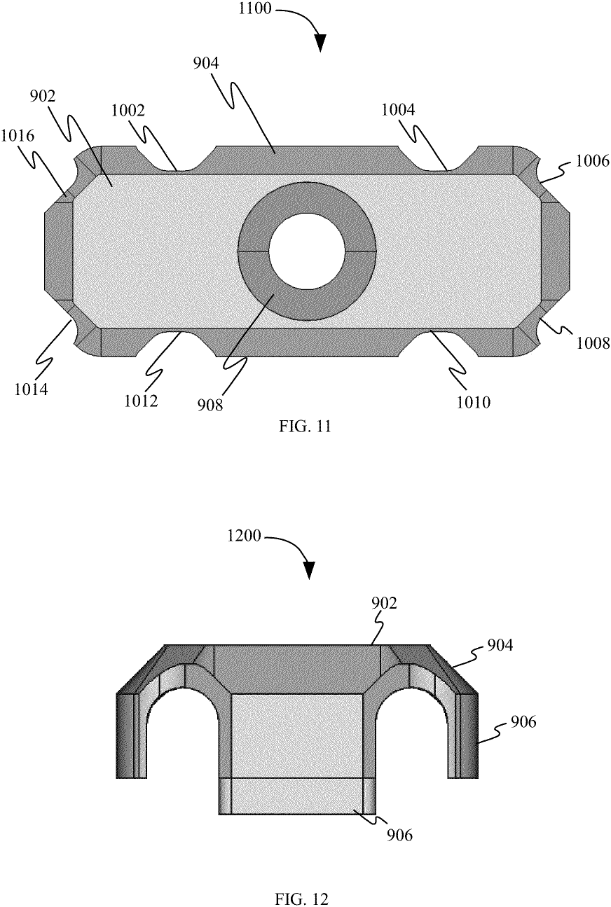

Referring now to FIG. 11, there is shown a top view 1100 of the firearm cable fastening device 900 for a firearm rail system. As can be seen in this example, there is a single beveled attachment opening 908 to affix the firearm cable fastening device 900 to the firearm rail system selected by the user. In this embodiment, the size and shape of the firearm cable attachment device 900 is more suited to smaller firearms, such as, for example, a pistol or handgun.

Referring now to FIG. 12, there is shown a front view 1200 of the firearm cable fastening device 900 for a firearm rail system. As can be seen, the connecting edge 904, in this case, is beveled. As discussed previously, the connecting edge 904 can be rounded, perpendicular or any other shape necessary to prevent the cable from a device attached to the firearm rail system from interfereing with the user’s view or operation of the firearm.

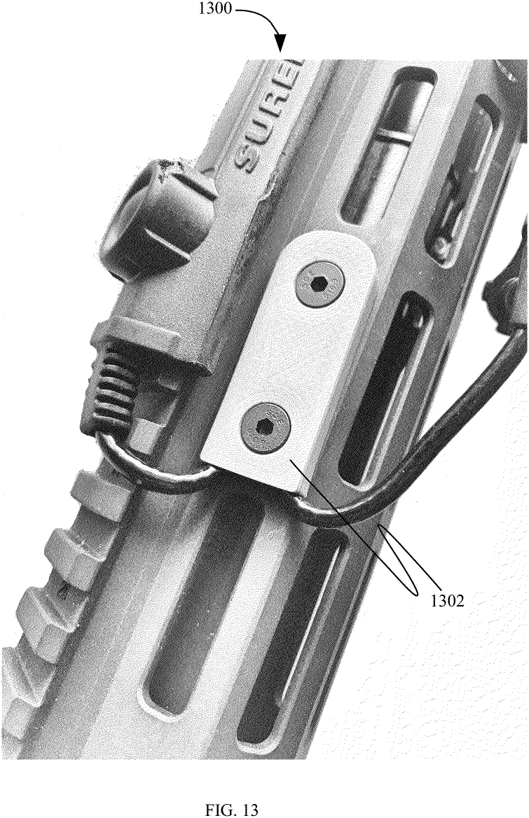

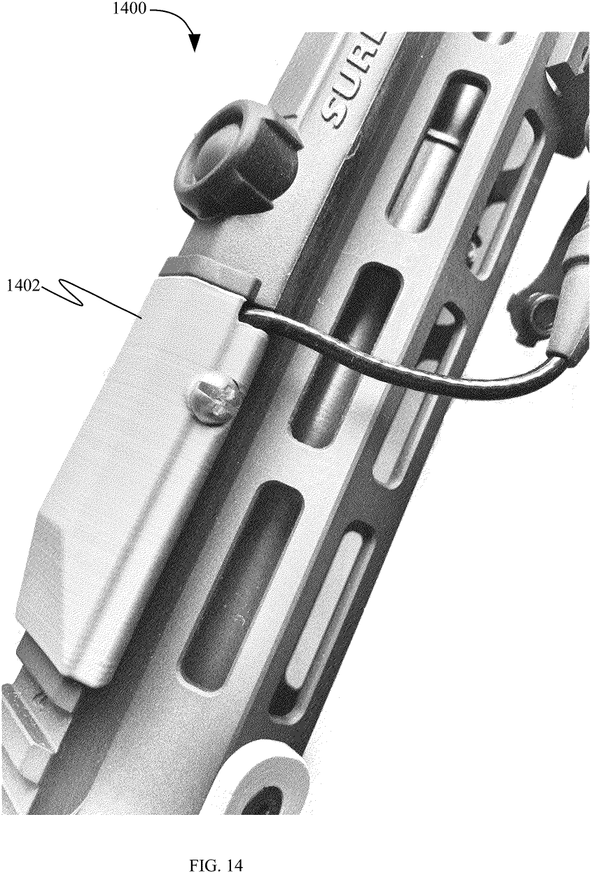

Referring now to FIG. 13, there is shown photographic view of a another embodiment of the device attached to an MLOK rail system. As cab be seen, using the present invention secures the rail attachment securely against the firearm rail system. This prevents the cable from interfering with the use of the firearm, increases safety for the user and extends the life of the attachment by preventing accidental snags or hang ups with other objects.

Referring now to FIG. 14, there is shown a is photographic view of a another embodiment of the device attached to an KeyMod rail system. As can be seen in the example, the top portion is smooth and rounded to protect a cable from the attached device from interfering with the use of the firearm. In this case, the design of the firearm cable fastening device 400 or 900 is aesthetically pleasing an merges seamlessly into the firearm rail system while providing safety and protection. Additionally, for this particular firearm rail system the one or more than one attachment opening 408-410 or 908 is in a different position, more along a side of the firearm cable fastening device 400 or 900. For this firearm rail system, the one or more than one attachment points require that the firearm cable fastening device 400 or 900 be in that position. As will be understood by those with skill in the art, the firearm rail system itself will determine the size, position and type of attachment used. In some instances, the attachment points may require an integrated friction lock, or other attachment means. Each attachment means know or unknown at the time of this document are contemplated for use in the device 400 or 900. Preferably, the attachment means comprises a locking lever mechanism without any attachment openings.

What has been described is a new and improved system for a firearm cable fastening device for a firearm rail system, that is quickly installed and secure, overcoming the limitations and disadvantages inherent in the related art.

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

What is claimed is:

1. A firearm cable fastening device comprising:
a) a top side portion;
c) one or more than one edge portion connected perpendicular to the top side portion;
d) one or more than one attachment means for attaching the firearm cable fastening device to a firearm rail system; and
e) one or more than one cable pass through indent in the one or more than one edge portion.

2. The device of claim 1, wherein the top portion is smooth and flat.

3. The device of claim 1, further comprising one or more than one connecting edge portion affixed to the top side portion and the one or more than one edge portion that is perpendicular to the top side portion.

4. The device of claim 3, wherein the one or more than one connecting edge is beveled.

5. The device of claim 3, wherein the one or more than one connecting edge is rounded.

6. The device of claim 1, wherein the one or more than one attachment means is a beveled opening.

7. The device of claim 1, wherein the one or more than one attachment means is quick release locking device.

8. The device of claim 1, wherein the one or more than one cable pass through indent is beveled.

9. The device of claim 1, wherein the one or more than one cable pass through indent is rounded.

10. The device of claim 1, further comprising one or more than one stand off post.

11. The device of claim 1, further comprising one or more than one stand off base.

12. The device of claim 11, wherein the the one or more than one stand off base comprises one or more than one stand off post.

13. A firearm cable fastening device comprising:
a) a top side portion, wherein the top portion is smooth and round without any edge portions;
b) one or more than one attachment means for attaching the device to a firearm rail system; and
c) one or more than one cable pass through indent.

14. The device of claim 13, further comprising one or more than one connecting edge portion affixed to the top side portion and the one or more than one edge portion perpendicular to the top side portion.

15. The device of claim 14, wherein the connecting edge is beveled.

16. The device of claim 14, wherein the connecting edge is rounded.
